(19) United States
(12) Patent Application Publication
(10) Pub. No.: US 2005/0241435 A1
(43) Pub. Date: Nov. 3, 2005

(54) Fork-like, direct link to shifter

(76) Inventor: Richard V. Colano, Burlington, WI (US)

Correspondence Address: JANSSON, SHUPE & MUNGER & ANTARAMIAN, LTD, 245 MAIN STREET, RACINE, WI, 53403, US

(21) Appl. No.: 10/837,091

(22) Filed: Apr. 30, 2004

(51) Int. Cl. G05G 9/00

(52) U.S. Cl. 74/560

(57) ABSTRACT

The invention is a foot-operated shift lever actuator for actuating a motorcycle gear shift lever. The shift-lever actuator has an elongate arm, which is pivotable with respect to the motorcycle. Integral with the elongate arm is a shift-lever-engaging member. Along the elongate arm is a first foot-contacting member, configured such that pressure applied to the first foot-contacting member induces a pivot motion of the elongate arm, thereby causing a vertical motion of the shift lever into the distinct shift positions.

### FIELD OF THE INVENTION

This invention is related generally to motorcycles and, more particularly, to shift actuators and to methods for customizing a motorcycle with shift actuators.

### BACKGROUND OF THE INVENTION

Standard touring motorcycles such as a Honda Goldwing®, Model GL1800, come with factory-installed pegs upon which to place the operator's feet while the motorcycle is in operation. Such touring motorcycles are shifted by means of a toe-operated shift lever on the left side of the motorcycle forward of the footpeg. Factory provided footpegs and shift levers are strategically placed on motorcycles to allow clearance when the motorcycle is canted from vertical in a cornering maneuver to allow for maximum cornering.

Despite the cornering economy of stock pegs, many riders prefer footboards. Footboards allow for a more stylish look than the stock footpegs. In addition, footboards support the entire foot thereby providing comfort to the rider during long tours. Therefore, many motorcycle owners modify their motorcycles through the replacement of footpeg with floorboards. Unfortunately, when footboards are retrofit to replace footpegs in a manner to maintain street clearance levels to preserve cornering ability, due to the added length of the footboard, the shift lever end becomes inaccessible to the operator thereby precluding operation of the motorcycle. To remedy such a situation, it is necessary to have a mechanism to link the foot to the shift lever.

### SUMMARY OF THE INVENTION

One embodiment of the invention involves a foot-operated shift lever actuator for actuating a motorcycle gear shift lever of the type having a rod-like shift-lever end movable in a generally vertical plane to distinct shift positions. The term “foot” is broadly used herein to include the foot and the foot enclosed, such as with a shoe or boot. In a similar manner, the term “toe” generally refers to the front portion of the foot, specifically including the ball of the foot, while the term “heel” includes the rer portion of the foot. The shift-lever actuator has an arm which is generally elongate with a first end and a second end. As used herein, the term “elongate” does not require linearity. As used herein, the term describes having a generally dominant longitudinal dimension, but specifically includes “L”, “S”, and “Z”-shaped ends and obtuse “V”-shapes, with a trough located between the ends. Moreover, the shape may have other deviations from linearity when viewed from other perspectives. The elongate arm is pivotable with respect to the motorcycle. Integral with the first end is a shift-lever-engaging member. The shift-lever-engaging member is interactively engaged with the shift-lever end. Along the elongate arm is a first foot-contacting member. In this way, pressure may be applied by a foot to the first foot-contacting projecting member. This pressure induces a pivot motion of the elongate arm about the pivot, thereby causing a vertical motion of the shift lever into the distinct shift positions. As used herein, the directions are given with reference to the motorcycle in upright operation. By way of example, the term “vertical” generally describes upward from the ground while the term “lateral” generally describes horizontal to the ground and outward from the side of the motorcycle. The pressure applied by the foot may selectively result in a clockwise or counterclockwise motion of the elongate arm about the pivot, typically in a vertical plane. This selection may be dependant on motorcycle gear patterns for the individual model of motorcycle. In one preferred embodiment, the first foot-contacting member is a front nub. In using the term “nub”, Applicant is describing a projection. The nub may be a knob, a bar, or any other shape projecting from the elongate arm. It is more preferred for the front nub to project laterally from the elongate arm.

As describe herein, a shift-lever-engaging member is integral with the first end and is interactively engaged with the shift-lever end. In one embodiment, the shift-lever-engaging member is fork-like with an upper tine and a lower tine. In a more preferred embodiment, the shift-lever-engaging member further comprises a shift-lever-end bushing. The shift-lever-end bushing has a bushing shift-lever-end receiving channel with an inner surface. The shift-lever-end receiving channel is configured and arranged to be complementary to an outer surface of the shift-lever end. By way of example only, if the shift-lever end had a cylindrical shape, the shift-lever-end receiving channel will also be cylindrical, while if the shift-lever end had a five-pointed-star-shaped cross-section, the shift-lever-end receiving channel will also five-pointed-star-shaped cross-section, dimensioned to engage the shift-lever end. The bushing also has a bushing outer surface. The bushing is located between the upper and lower tines, typically such that the tines neatly engage the bushing outer surface. One of the attributes of an embodiment with a bushing is that in practice, it is found that a practitioner can well control the quality of the tines-to-bushing engagement. In some embodiments, typically when the shift-lever end has a non-circular cross-section, the bushing is rotatable with respect to the upper and lower tines. In some embodiments, more typically when the shift-lever end has a circular cross-section, the bushing is rotatable with respect to the shift-lever end.

In another preferred embodiment, the foot-operated shift lever actuator further comprises a footboard. A footboard as described herein is configured and arranged to support a foot; a footboard is distinguishable from a peg in that a footboard is longitudinally dimensioned to support nearly the entire foot length of most operators. The footboard has a vertical pivot-support member retaining the pivot. The footboard is attached to the motorcycle. It is more preferable for the footboard to support the foot in a substantially horizontal position.

In a preferred embodiment, the first foot-contacting member is located between the pivot point and the shift-lever-engaging member. In a more specific embodiment of the invention, the foot-operated shift lever actuator further comprises a second foot-contacting member, which is attached to the elongate arm between the pivot point and the second end. It is more preferable for the second foot-contacting member to be a back nub. It is even more preferable for the back nub to project laterally from the elongate arm.

In another preferred embodiment, the second foot-contacting member is selectively repositionable along the elongate arm. Such selectivity allows for adjustment options in generally horizontal positions to accommodate feet of different lengths. By referring to generally horizontal positions, Applicant is specifically observing that in such embodiments, the adjustment options are typically along the portion of the elongate arm between the pivot point and the second end. Such portion of the elongate arm may make an acute angle with regard to the horizontal plane thereby making the adjustment options generally horizontal to the extent that the options offered have the same linearity as the portion of the elongate arm between the pivot point and the second end.

In yet another preferred embodiment, it is preferable for the first foot-contacting member to be selectively repositionable on the elongate arm with regard to the shift-lever-engaging member. Such selectivity allows for adjustment options in vertical and horizontal positions to accommodate feet of different dimensions.

Another aspect of the invention involves a method for customizing or retro-fitting a motorcycle of the type having a motorcycle gear shift lever with a rod-like shift-lever end movable in a generally vertical plane to distinct shift positions and having a peg-receiving aperture. The method comprises the steps of: (1) obtaining a footboard configured and arranged to support a foot, (2) attaching the floorboard to the motorcycle, and (3) interactively attaching the shift-lever-engaging member with respect to the shift-lever end. The footboard has a vertical pivot-support member retaining a pivot, a footboard attachment device for attaching the footboard to the motorcycle, an elongate arm having a first end and a second end, pivotably attached to the pivot at a pivot point dispensed from the first end, a shift-lever-engaging member integral with the first end, interactively engaged with the shift-lever end, and a first foot-contacting member attached to the elongate arm.

In one preferred embodiment of the method, the footboard attachment device is configured for attachment to the peg-receiving aperture. In such an embodiment, the embodiment comprises the additional step of removing a peg, which may have been originally supplied as a stock part for the motorcycle, from the peg-receiving aperture.

Another preferred embodiment of the method for customizing a motorcycle comprises the additional steps of: (4) obtaining a bushing with a bushing outer surface configured to interact with shift-lever-engaging member, (5) enveloping the shift-lever end with the bushing; and (6) interactively attaching the shift-lever-engaging member to the bushing outer surface. The bushing also has a bushing inner surface defining a shift-lever-end receiving channel configured and arranged to be complementary to an outer surface of the shift-lever end.

It is yet another aspect of the invention to present a foot-operated shift lever motivator for moving a motorcycle gear shift lever in a generally vertical plane to distinct shift positions. Such a shift-lever motivator comprises: a floorboard attached to the motorcycle having a vertical tab, an elongate arm, a fork member, a bushing, and a first foot-contacting member. The elongate arm has a first end and a second end. The elongate arm is rotatably attached to the vertical tab at a pivot point, which is dispensed from the first end. The fork member is integral with the first end. The fork member has an upper tine with a lower surface and a lower tine with an upper surface such that there exists a tine dimension between the upper and lower surfaces. The bushing has a central cavity with an axis and with a shape complementary to an outer surface of the motorcycle gear shift lever. In this way, the bushing can envelop a portion of the motorcycle gear shift lever. The bushing also has an outer surface substantially concentric to the central cavity axis and dimensioned to be substantially equal to the tine dimension. In this way, the bushing is snugly engaged between the upper and lower surfaces. The first foot-contacting member is attached to the elongate arm at a foot-contacting-member point between the fork member and the pivot point. It is more preferable for the foot-operated shift lever motivator to have a second foot-contacting member attached to the elongate arm between the pivot point and the second end.

### BRIEF DESCRIPTION OF THE DRAWINGS

The drawings illustrate preferred embodiments which include the above-noted characteristics and features of the invention. The invention will be readily understood from the descriptions and drawings. In the drawings:

FIG. 1 is a perspective view of the lower portion of the left side of a motorcycle of the prior art.

FIG. 2 is a perspective view of a motorcycle footboard attached to the lower portion of a motorcycle.

FIG. 3 is a top view of a left, driver footboard with a shifter arm and toe and heel knobs.

FIG. 4 is a side view of the footboard of FIG. 3.

FIG. 5 is a front view of the footboard of FIG. 3.

FIG. 6 is a side view of a preferred embodiment of a shifter arm.

FIG. 7 is a side view of another preferred embodiment of a shifter arm.

FIG. 8 is a side view of a bushing.

FIG. 9 is a back view of a bushing.

FIG. 10 is a side view of a foot on a footboard encountering the underside of the front toe knob.

FIG. 11 is a side view of a foot on a footboard encountering the top of a front toe knob.

FIG. 12 is a side view of a foot on a footboard with the heel encountering the heel knob.

### DETAILED DESCRIPTION OF PREFERRED EMBODIMENTS

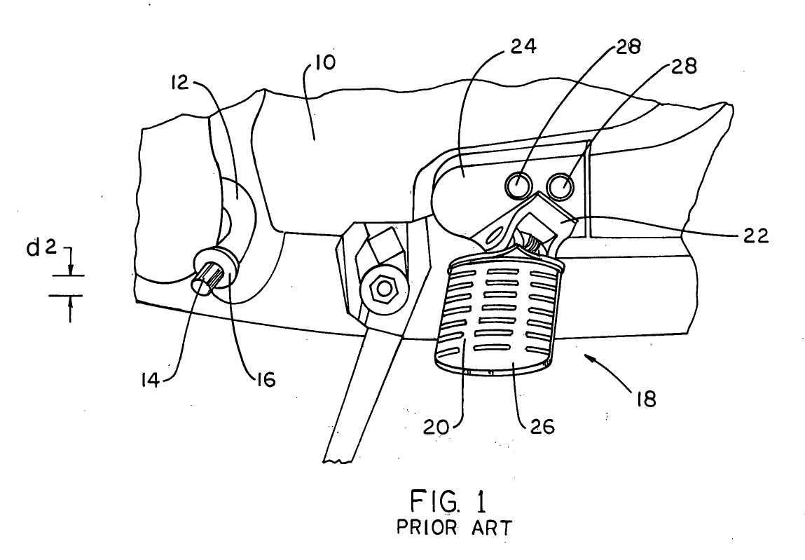

FIG. 1 shows a portion of the left side of a motorcycle 10 of the prior art. In particular, such motorcycle 10 is a touring-type such as a Honda Goldwing® Model GL1800, sold throughout the world.

Motorcycle 10 is of the type having a shift lever 12 attached to the transmission system (not shown). Shift lever 12 extends laterally out from motorcycle 10 and terminates in a shift lever end 14. Shift lever end 14 is most typically covered with a cylindrical end cap (not shown). End cap cover shift lever end 14 up to collar 16. Cap is removable and shift lever end 14 is shown with cap removed.

Also as part of the standard equipment for motorcycle 10 is a left footpeg 18 which extends laterally out from motorcycle 10. Left footpeg 18 consists of peg body 20, hinge 22, and attachment bracket 24. Peg body 20 has a generally flat peg surface 26. Peg surface 26 has a resilient and durable coating designed to both last and to provide an anti-slip surface for an operator's foot. Peg body 20 is attached to hinge 22 to allow for peg body 20 to be rotated about hinge 22 up to motorcycle 10. Hinge 22 is attached to attachment bracket 24. Such attachment could be by any means including welding or integral fabrication between these components. Attachment bracket 24 is attached to motorcycle 10 by means of bracket bolts 28 extending through attachment bracket 24 to provide for securement to motorcycle 10. In the case of a Goldwing, such bracket bolts are 6 mm allen-head type.

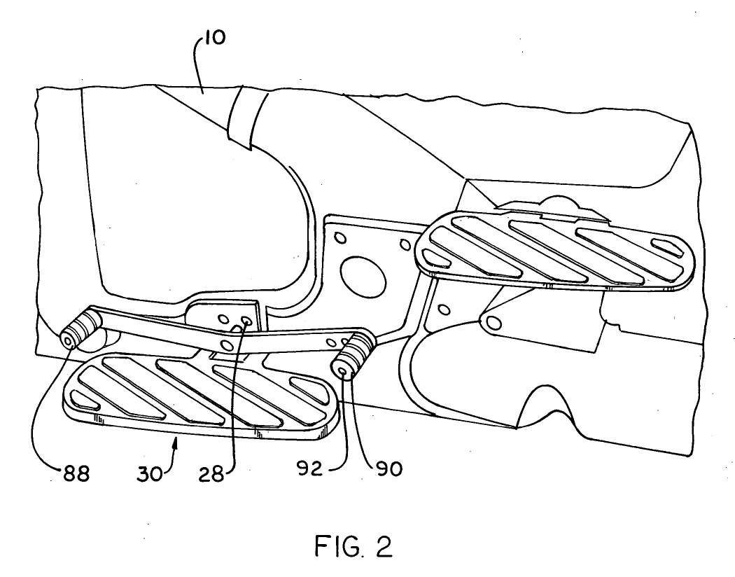

As seen in FIG. 2, a floorboard assembly 30 of this invention is attached to a portion of the left side of motorcycle 10.

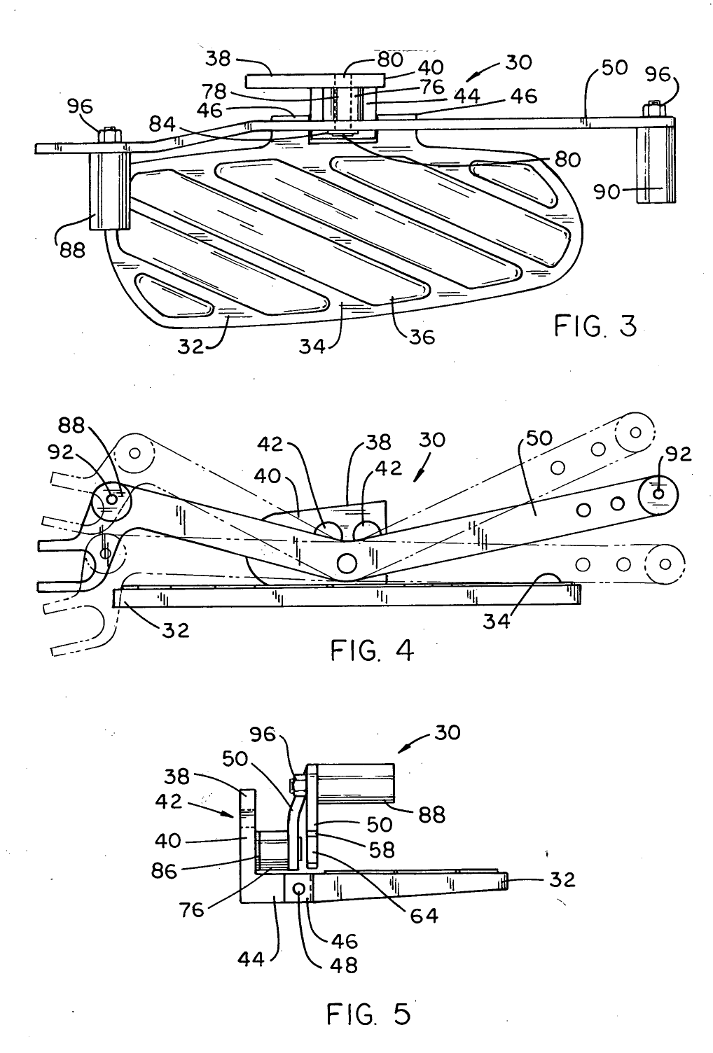

As better seen in FIGS. 3-5, floorboard assembly 30 has a floorboard 32. Floorboard 32 is typically made of metal for durability and preferably from billet aircraft-quality aluminum for strength and weight considerations. Floorboard 32 has a foot-receiving top surface 34. Top surface 34 is typically flat and is dimensioned to comfortably and fully receive an operator's foot. Floorboard 32 typically has a longitudinal dimension of about 12 inches and a lateral dimension of approximately 5 inches. Taking the dimensions and shape of the foot into consideration, the choice of geometric form of floorboard is arbitrary and subject to ornamental preference. Attached to floorboard top surface 34 are grip strips 36. Grip strips 36 are rubber inlays inlaid into recessed portions of floorboard surface 34 to provide a non-slip surface for feet. Grip strips 36 are typically made of a rubber such as neoprene to provide both durability, an anti-vibrational padding, and a non-slip material. Represented as diagonal strips relative to a longitudinal centerline of floorboard 32, it will be recognized that such arrangement is merely ornamental and that any arrangement about the surface of any configuration (including nonstrip-like geographic shapes) is satisfactory.

Also supplied is a L-shaped footboard attachment bracket 38. As seen in FIG. 4, footboard attachment bracket 38 has a bracket vertical portion 40 of the same profile as attachment bracket 24 (seen in FIG. 1). Maintaining the same profile between replacement footboard attachment bracket 38 and original equipment manufacture stock attachment bracket 24 allows for easy retrofit installation of the footboard assembly 30 onto motorcycle 10 (as seen in FIG. 2). For a similar reason, vertical portion 40 has two bolt holes 42 sized and spaced to accommodate bracket bolts 28 for attachment to motorcycle 10.

Perpendicular to, and integral with, vertical member 40 is horizontal member 44. Horizontal member 44 extends between ears 46 of footboard 32. Each of horizontal member and ears 44, 46 have a cylindrical channel (not shown) extending longitudinally therethrough. Hinge rod 48 (best seen in FIG. 5) extends through ears and horizontal member 44, 46 thereby attaching footboard attachment bracket 38 to footboard 32. In certain applications, it is desirable to allow hinge rod 48 to act as an axis about which footboard 32 can rotate relative to footboard attachment bracket 38. For instance, if dragged through a tight turn, hinged footboard 32 will retract away from traveling surface by rotation about hinge rod 48 when footboard 32 encounters traveling surface, rather than break off. Hinge rod 48 typically has means to inhibit longitudinal movement once installed (e.g., an enlarged bolt head at one end and cotter pin at the other end of hinge rod 48).

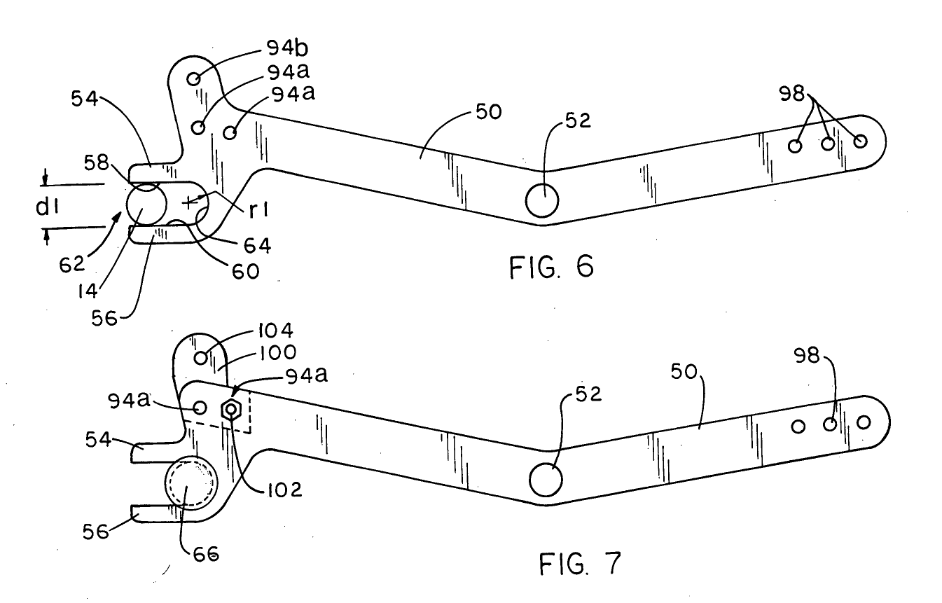

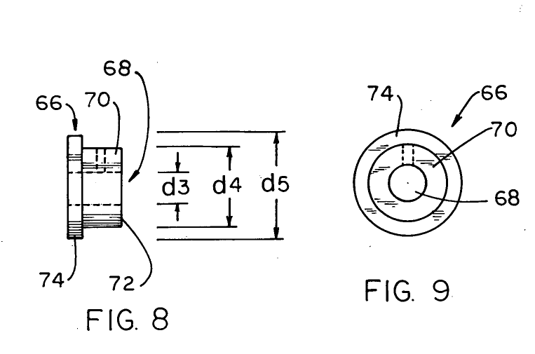

Floorboard assembly 30 also has shifter arm 50. As better seen in FIGS. 6 & 7, shifter arm 50 generally has a V-shape profile. At the apex of the “V” is a pivot port 52. As seen in FIGS. 3 and 5, shifter arm 50 has a deviation from linearity along its length when viewed from top.

As seen in FIG. 6, shifter arm 50 has upper and lower tines 54, 56. Upper tine 54 has a lower surface 58. Lower tine 56 has an upper surface 60 such that upper tine lower surface 58 and lower tine upper surface 60 are spaced apart a distance d₁, creating a tine channel 62. Tine channel 62 has a back surface 64. Tine channel back surface 64 has a generally circular profile with radius r₁, which is one half of the dimension d₁. In one embodiment, tine distance d₁ is substantially equal to a shift lever end diameter d₂ (seen in FIG. 1). In this way, shifter arm 50 may be directly and snugly linked to shift lever end 14.

In another embodiment a bushing 66 is used. Bushing 66 is cylindrical having a cylindrical bushing channel 68 extending therethrough of bushing channel diameter d₃. Bushing channel diameter d₃ is substantially similar to shift lever end diameter d₂, such that bushing 66 may be installed over shift lever end 14. Bushing 66 has a cylindrical body portion 70 of diameter d₄ which is cylindrically concentric with bushing channel 68. In this embodiment, tine distance d₁ is equal to bushing body portion diameter d₄ such that bushing 66 is snugly engaged by upper tine lower surface and lower tine upper surface 58, 60. For clarity, it will be observed that the dimension d₁ is configured to be substantially larger if designed to directly encounter bushing 66 rather than shift lever end 14 as described in the previous embodiment.

Bushing 66 has an inside surface 72 which abuts collar portion 16 when fully installed on motorcycle 10 about shift lever end 14. Bushing 66 has collar portion 72 of a diameter d₅ which is greater than bushing body portion diameter d₄. When installed on motorcycle 10, bushing collar portion 74 serves to prevent lateral motion of shifter arm 50 away from motorcycle 10 in the event that in operation, bushing body portion diameter d₄ fluctuates for any reason allowing for loose interaction between upper tine lower surface and lower tine upper surface 58, 60 with bushing body 70 (e.g., such fluctuations due to thermal activity).

Shifter arm 50 is pivotably attached with respect footboard attachment bracket 38. Shifter arm 50 is spaced apart from vertical member attachment bracket 40 by means of cylindrical pivot spacer 76. In one preferred embodiment, cylindrical pivot spacer 76 is integral with shifter arm 50 and has a cylindrical pivot-shaft channel 78 extending therethrough and coincident with pivot port 52. Pivot shaft 80 extends through pivot port 52 and pivot-shaft channel 78 and is secured to vertical member 40, thereby securing shifter arm 50 to footboard attachment bracket 38. One such means of securement is through installation of a threaded male pivot shaft 80 into a threaded female port 82. Even though shifter arm is secured to footboard attachment bracket 38 to prevent longitudinal torquing about pivot shaft 80 (i.e., in a vertical plane, said vertical plane extending laterally from the bike), it will be understood that said securement allows for radial rotational motion about the pivot. To facilitate radial motion about pivot shaft 80, pivot shaft bushing 84 is installed between pivot shaft 80 and shifter arm 50 and pivot spacer bushing 86 is located between cylindrical pivot spacer 76 and vertical member 40 (as seen in FIGS. 3 and 5).

Alternatively, cylindrical pivot spacer 76 may be integral with vertical member 40. In such an embodiment, pivot spacer bushing 86 is located between cylindrical pivot spacer 76 and shifter arm 50. As a further alternative, cylindrical pivot spacer 76 may be independent of both vertical member 40 and shifter arm 50; in such event, a second pivot spacer bushing 86 is installed such that a pivot spacer bushing 86 is located between vertical member and pivot spacer while a second pivot spacer bushing 86 is located between pivot spacer and shifter arm 50.

As seen in FIGS. 2-5, toe knob 88 and heel knob 90 are attached to shifter arm 50. Toe knob 88 and heel knob 90 are attached to shifter arm 50 by means of knob bolts 92. Knob bolts 92 have a recessed hexed, allen-type head with a threaded shank. Knob bolt 92 extends through toe knob 88 and toe knob lever hole 94 before being secured by acorn nut 96. In a similar manner, heel knob 90 is attached to shifter lever 50 by means of knob bolt 92 inserted through heel knob 90 and secured by acorn nut 96 (as seen in FIGS. 3 and 5).

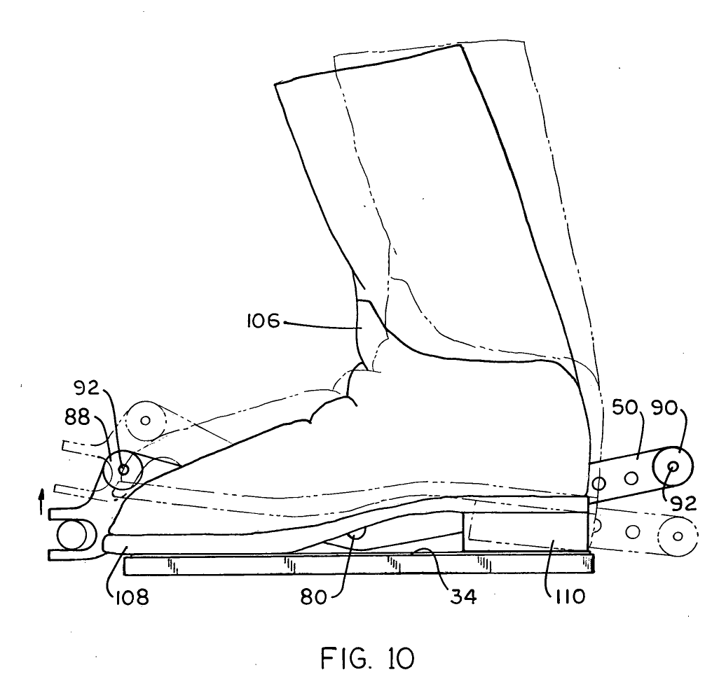

As seen in FIG. 6, toe knob lever holes 94 may be dispensed substantially horizontally along shifter lever 50 providing placement options 94a to allow for placement options to adjust to different foot lengths. Additionally, an alternate vertical location 94b is provided to allow for placement on shift lever 50 to accommodate placement of a toe between toe knob 50 and footboard upper surface 34 as seen in FIG. 10. In a like manner, heel knob lever holes 98 are spaced along shifter lever 50 to allow for placement options to accommodate different foot lengths.

As an alternative embodiment, a vertical placement option for the toe knob may be provided through vertical extension piece 100. Vertical extension piece 100 is attached to shift lever 50 by means of extension bolts 102 extending through toe knob lever holes 94a and toe knob extension holes 104. The vertical extension piece 100 secured to shifter lever 50 toe lever extension hole 104 may be used for securing toe knob 88 to vertical extension piece 100 by means of knob bolt 92 and acorn nut 96 as described above.

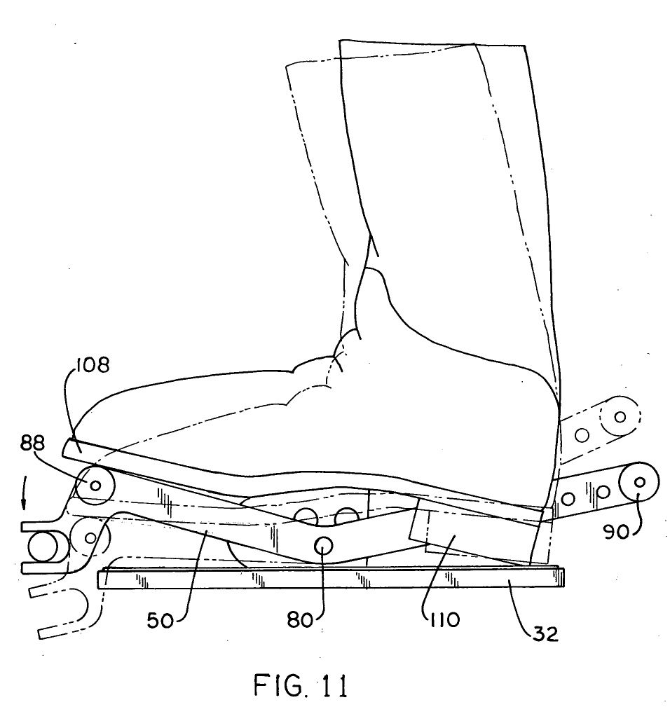

FIGS. 10, 11 and 12 show shift lever 50 in operation. As seen in FIG. 10, a foot 106 rests on floorboard upper surface 34. As shown, toe 108 and heel 110 encounter footboard 32. In order to selectively shift into and out of various gears, it becomes necessary to selectively move shift lever end 14 in either an upward or downward manner. Before shifting into or out of gear, first hand clutch (not shown) is engaged. With hand clutch engaged, in order to induce a downward motion in the shift lever end 14, toe 108, as seen in FIG. 11 encounters toe knob 88 pressing downward thereon in inducing a counter-clockwise rotation about pivot shaft 80 thereby forcing upper and lower tines 54, 56, busing 66 and shaft lever end 14 all in a downward motion relative to the motorcycle.

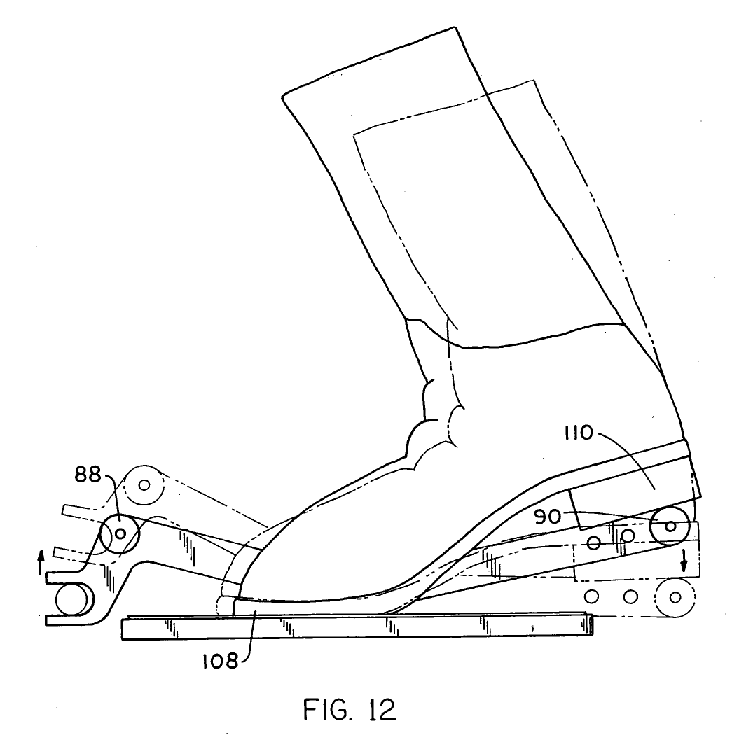

To induce an upward motion of shift lever end 14, as seen in FIG. 12, heel 110 encounters heel knob 90 pushing down thereon. The downward force applied to heel knob 90 induces a clockwise rotation of shift lever 50 about pivot shaft 80 thereby forcing upper and lower tines 54, 56 and bushing 66 and shift lever end 14 upward.

A selective upward motion of shift lever end 14 can also be accomplished through motion of toe as seen in FIG. 10. Toe 108 can encounter toe knob 88 pushing up thereon, thereby inducing a clockwise rotation of shift lever 50 thereby raising shift lever end 14, as described above.

The figures also disclose a method for retrofitting motorcycle 10 with floorboard assembly 30. As seen in FIG. 1, motorcycle 10 typically comes with stock equipment such as shift lever 12 and left peg 18. First, rubber cover (not shown) which typically comes over shift lever end 14, is simply removed by pulling it from shift lever end 14. Shift lever end 14 is then revealed. Due to the length of shift lever end 14, a portion may need to be removed typically by cutting with a hacksaw leaving shift lever end 14 as shown with a portion extending laterally outward from collar 16. Left peg 18 is removed by unscrewing bracket bolts 28. Once bracket bolts 28 are removed from motorcycle 10, attachment bracket 24 and left footpeg 18 may be removed from the motorcycle. Although upper and lower tines 54, 56 may directly engage shift lever end 14, it is preferable to install bushing 66 over shift lever end 14. This is accomplished by first inserting bushing 66 between upper tine lower surface and lower tine upper surface 58, 60 such that bushing inner surface 72 faces inward toward the bike while bushing collar portion 74 is laterally remote from the bike. Floorboard attachment bracket 38 is attached to motorcycle 10 by means of bracket bolts screwed back through bolt holes 42 and into motorcycle 10. With footboard attachment bracket 38 firmly affixed to motorcycle 10, bushing 66 may be installed over shift lever end 14. This is accomplished by inserting shift lever end 14 into bushing channel 68, pushing on collar portion 16 laterally until bushing inner surface 72 abuts collar 16. Care will be taken to make certain that bushing collar portion 74 does not encounter either upper tine 54 or lower tine 56. In some applications, it will be desirable to lubricate bushing body portion 70 to allow for relative rotational motion between bushing body portion 70 and upper tine lower surface and lower tine upper surfaces 58, 60. In this type of installation, it is preferable that bushing inner surface 72 does not rotate with respect to shift lever end 14. In this embodiment, when clockwise rotational motion is imparted to elongate arm 50 by means of force applied to heel knob 90, shift lever 12 will be raised with slight rotation between upper and lower tines 54, 56 and bushing 66.

Alternatively, it may be preferable to lubricate between bushing channel 68 and shift lever end 14. In this type of embodiment, upper tine lower surface and lower tine upper surface 58, 60 jointly secure bushing 66 such that there is no relative rotational motion between bushing 66 and tines 54, 56. With a similar clockwise rotation of elongate shifter arm 50 imparted by pressure to heel knob 90, shift lever 12 will raise with slight rotation of bushing 66 with respect to shift lever end 14.

While the principles of the invention have been shown and described in connection with specific embodiments, it is to be understood that such embodiments are by way of example and are not limiting.

1. A foot-operated shift lever actuator for actuating a motorcycle gear shift lever of a motorcycle, said motorcycle-gear-shift lever of the type having an elongated shift-lever end movable in a generally vertical plane to distinct shift positions, the shift-lever actuator comprising:
a pivot attached with respect to the motorcycle;
an elongate arm having a first end and a second end, pivotably attached to the pivot at a pivot point located between the first end and the second end, and dispensed from the first end; and from the second end, the first end with a shift-lever-engaging member, which shift-lever-engaging member is interactively engaged with the shift-lever end and is configured and arranged to spatially displace the shift lever when the elongate arm is rotated about the pivot; and
a first foot-contacting member attached to the elongate arm;
whereby pressure applied by a foot to the first foot-contacting member induces a pivot motion of the elongate arm about the pivot, thereby causing a vertical motion of the shift lever into the distinct shift position.

2. The foot-operated shift lever actuator of claim 1 wherein the first foot-contacting member is a front nub.

3. The foot-operated shift lever actuator of claim 2 wherein the front nub projects laterally from the elongate arm.

4. The foot-operated shift lever actuator of claim 1 wherein the shift-lever-engaging member has an upper tine and a lower tine.

5. The foot-operated shift lever actuator of claim 4 wherein the shift-lever-engaging member further has a shift-lever-end bushing with a bushing inner surface defining a shift-lever-end receiving channel configured and arranged to be complementary to an outer surface of the shift-lever end, and with a bushing outer surface, said bushing located between the upper and lower tines.

6. The foot-operated shift lever actuator of claim 5 wherein the bushing is rotatable with respect to the upper and lower tines.

7. The foot-operated shift lever actuator of claim 5 wherein the bushing is rotatable with respect to the shift-lever end.

8. The foot-operated shift lever actuator of claim 1 further comprising a footboard, configured and arranged to support a foot, and having a vertical pivot-support member retaining the pivot, said footboard attached to the motorcycle.

9. The foot-operated shift lever actuator of claim 8 wherein the footboard supports the foot in a substantially horizontal position.

10. The foot-operated shift lever actuator of claim 8 wherein the first foot-contacting member is located between the pivot point and the shift-lever-engaging member.

11. The foot-operated shift lever actuator of claim 10 further comprising a second foot-contacting member attached to the elongate arm between the pivot point and the second end.

12. The foot-operated shift lever actuator of claim 11 wherein the second foot-contacting member is a back nub.

13. The foot-operated shift lever actuator of claim 12 wherein the back nub projects laterally from the elongate arm.

14. The foot-operated shift lever actuator of claim 11 wherein the second foot-contacting member is configured to be selectively repositioned along the elongate arm.

15. The foot-operated shift lever actuator of claim 1 wherein the first foot-contacting member is configured to be selectively repositioned on the elongate arm with regard to the shift-lever-engaging member.

16. A method for customizing a motorcycle of the type having a motorcycle gear shift lever with a rod-like shift-lever end movable in a generally vertical plane to distinct shift positions and having a peg-receiving aperture, comprising the steps of:
obtaining a footboard configured and arranged to support a foot, and having:
a vertical pivot-support member retaining a pivot,
a footboard attachment device for attaching the footboard to the motorcycle;
an elongate arm having a first end and a second end, pivotably attached to the pivot at a pivot point dispensed from the first end;
a shift-lever-engaging member integral with the first end, interactively engaged with the shift-lever end; and
a first foot-contacting member attached to the elongate arm;
attaching the floorboard to the motorcycle; and
interactively attaching the shift-lever-engaging member with respect to the shift-lever end.

17. (canceled)

18. (canceled)

19. (canceled)

20. (canceled)

21. A foot-operated shift lever motivator for moving a motorcycle gear shift lever in a generally vertical plane to distinct shift positions, the shift-lever motivator comprising:
a floorboard having a vertical tab, said floorboard attached to a motorcycle;
an elongate arm having a first end and a second end, rotatably attached to the vertical tab at a pivot point dispensed from the first end;
a fork member integral with the first end, having an upper tine with a lower surface and a lower tine with an upper surface configured such there exists a tine dimension between the upper and lower surfaces; and
a first foot-contacting member attached to the elongate arm at a foot-contacting-member point between the fork member and the pivot point.

22. (canceled)

23. The foot-operated shift lever motivator of claim 21 further comprising a second foot-contacting member attached to the elongate arm between the pivot point and the second end.

24. A foot-operated shift-lever actuator for actuating a motorcycle gear shift lever for a motorcycle, of the type having a shift-lever end movable in a generally vertical plane to distinct shift positions, the shift-lever actuator comprising:
a pivot attached with respect to the motorcycle;
an elongate arm having a first end, said elongate arm pivotably attached to the pivot at a pivot point dispensed from the first end;
a first foot-contacting member attached to the elongate arm; and
a shift-lever-end-engaging member integral with the elongate arm and dispensed from the pivot, interactively engaged with the shift-lever end, having a shift-lever-end engaging upper surface, which shift-lever-end engaging upper surface is configured and arranged to urge the shift-lever end in an upward direction in the vertical plane when a clockwise motion is imparted to the elongate arm by application of a clockwise-motion-of-the-first-foot-contacting-member-about-the-pivot-producing force to the first foot-contacting member; and having a shift-lever-end engaging lower surface, which shift-lever-end engaging lower surface is configured and arranged to urge the shift-lever end in an downward direction in the vertical plane when a counter-clockwise motion is imparted to the elongate arm by application of a counter-clockwise-motion-of-the-first-foot-contacting-member-about-the-pivot-producing force to the first foot-contacting member.

25. A foot-operated shift lever actuator for actuating a motorcycle gear shift lever of a motorcycle, said motorcycle-gear-shift lever of the type having an elongated shift-lever end movable in a generally vertical plane to distinct shift positions, the shift-lever actuator comprising:
a pivot attached with respect to the motorcycle;
an elongate arm having a first end and a second end, pivotably attached to the pivot at a pivot point located between the first end and the second end, said pivot point dispensed from the first end and from the second end, the first end with a shift-lever-engaging member, which shift-lever-engaging member is integral with the first end, and is interactively engaged with the shift-lever end;
a first foot-contacting member attached to the elongate arm, said first foot-contacting member located between the pivot point and the shift-lever-engaging member;
second foot-contacting back nub attached to the elongate arm between the pivot point and the second end, said second foot-contacting back nub is configured to be selectively repositioned along the elongate arm; and
a footboard, configured and arranged to support a foot, and having a vertical pivot-support member retaining the pivot, said footboard attached to the motorcycle, whereby pressure applied by a foot to the first foot-contacting member induces a pivot motion of the elongate arm about the pivot, thereby causing a vertical motion of the shift lever into the distinct shift position.

26. The foot-operated shift lever actuator of claim 25 wherein the back nub projects laterally from the elongate arm.
